(19) United States
(12) Patent Application Publication
(10) Pub. No.: US 2016/0292076 A1
(43) Pub. Date: Oct. 6, 2016

(54) APPARATUS, PROGRAM, AND METHOD FOR UPDATING CACHE MEMORY

(71) Applicant: FUJITSU LIMITED, Kawasaki-shi (JP)

(72) Inventors: Vivian LEE, Bracknell Berkshire (GB); Roger MENDAY, Guilford Surrey (GB)

(73) Assignee: FUJITSU LIMITED, Kawasaki-shi (JP)

(21) Appl. No.: 15/051,220

(22) Filed: Feb. 23, 2016

(30) Foreign Application Priority Data
Mar. 31, 2015 (GB) 1505550.2

(51) Int. Cl. G06F 12/08; G06F 17/30

(52) U.S. Cl. CPC G06F 12/0877; G06F 17/30312; G06F 2212/1016; G06F 2212/603

(57) ABSTRACT

A dataflow controller to store dataflow specifications and to control execution of the dataflow specified the specification specifying a series of linked data processing steps, each step specifying a processing operation to generate output data, and each link defining a consecutive pair relationship between two steps within the series, the link instructing the dataflow controller to trigger execution of the preceding member of the pair by, providing the output data of the member as the input data of the member; and a cache memory and memory controller, the memory controller to maintain an accumulation of the output data generated by the most recent execution of the operation of each member of a set of the steps specified by the dataflow controller; the dataflow controller upon execution of the operation of the step, to provide the output data to the memory controller; the memory controller, to update the maintained accumulation.

### CROSS-REFERENCE TO RELATED APPLICATIONS

This application claims the benefit of United Kingdom Application No. 1505550.0, filed Mar. 31, 2015, the disclosure of which is incorporated herein by reference.

### BACKGROUND

1. Field

The present invention lies in the field of cache memory control, and in particular relates to the maintenance of the latest versions of particular data items on a cache memory.

2. Description of the Related Art

While processing speed is crucial to the success of a business in the current Big Data era, many systems provide data analysis capability as a batch process, which is often insufficient comparing to an incremental approach. Thus, the data being analyzed may be old or invalid.

In other systems, a natural way of structuring information data items is not necessary optimal for the collective processing of such data items. For example, data items spread across multiple database tables or in a network structure. This is not compatible with many analytics software that expects data in a tabular input form.

Traditional business processing models are realized by sequential, control flow, or imperative programming. Recently, dataflow programming is becoming increasingly dominant because of its data centric nature, e.g. it emphasizes the movement of data and defines series of connections as its processing method. This type of processing flow is inherently parallel and decentralized, therefore, can answer Big Data processing challenges well.

It is desirable to provide a means of providing data for analytics programs that interacts with dataflow programming and execution of dataflows.

### SUMMARY

Additional aspects and/or advantages will be set forth in part in the description which follows and, in part, will be apparent from the description, or may be learned by practice of the invention.

Embodiments include an apparatus, comprising: a dataflow controller configured to store one or more dataflow specifications and to control execution of the dataflow specified by the or each dataflow specification, the or each dataflow specification specifying a series of linked data processing steps, each processing step specifying a processing operation to be performed on data provided as input data in order to generate output data, and each link defining a consecutive pair relationship between two processing steps within the series, the link instructing the dataflow controller to trigger the execution of the preceding member of the consecutive pair by, upon generation of the output data by the preceding member, providing the generated output data of the preceding member as the input data of the preceding member; and a cache memory and cache memory controller, the cache memory controller being configured to maintain, on the cache memory, an accumulation of the output data generated by the most recent execution of the processing operation of each member of a set of the data processing steps specified by the dataflow controller; the dataflow controller being configured, for each member of the set of data processing steps, upon execution of the processing operation of the data processing step, to provide the generated output data directly to the cache memory controller; the cache memory controller being configured, upon being provided the generated output data directly from the dataflow controller, to update the maintained accumulation.

Advantageously, embodiments enable up to date reports, in the form of data accumulations, featuring the latest version of one or more processing steps performed within dataflows, to be maintained in a cache memory. In particular, this is preferable to compiling accumulations by reading from locations within a data store itself, since the combined time it takes to write data generated by a processing step to the data store, and then to be alerted of the writing and to make a read access to extract the data for an accumulation, can be prohibitively long and lead to the accumulation being out of date.

The term accumulation is used to indicate that there are data output by a plurality of different processing steps, possibly from different dataflows, that are being maintained together. An accumulation may also be considered to be a view or snapshot, since it makes the state of a plurality of data items at a point in time visible (accessible) to other parties/applications/processes.

Embodiments take advantage of the fact that existing data from a data store are processed, and new data for the data store generated, during dataflow processing. In other words, since these data have been read from, or are awaiting writing to, the data store, they are more accessible than they would be were they to be in the data store itself. Furthermore, by obtaining data directly from the dataflow controller upon those data being output by the respective processing step, validity of the data is enhanced due to the relatively short time between generation and accumulation update, compared with reading from the data store itself.

Furthermore, embodiments may access data in intermediate forms that would not appear in the data store, for example, data may be read from the data store and provided to a processing step as an input, the output of that processing step may be a member of the set of data processing steps for which the output data is provided directly to the cache memory controller, however, there may be more data processing steps before output data is generated that will be written back to the data store. Thus, the data is in an intermediate form which would not be available to other parties/applications/processes by simply reading from the data store.

The dataflow controller and the stored dataflow specifications provide a means to manage the execution of a dataflow. The actual processing operations themselves are carried out by a processor which may be as a consequence of code being executed by the dataflow controller itself or may be as a consequence of code being executed by a separate component or device external to the apparatus. The dataflow controller may be configured to trigger a dataflow to execute in response to a notification of a data modification event at data fulfilling an input criterion defined for the dataflow.

The dataflow controller is at least configured to trigger each processing step by providing the input data to the processing step (or the entity responsible for its execution) and to receive the output data generated by the execution of the specified processing operation. The received output data may then be provided to a preceding processing step (or the entity responsible for its execution) in the dataflow as input data.

The links between processing steps may be explicitly defined by a user and stored by the dataflow controller. Alternatively or additionally, links may be derived by the dataflow controller based on the specified input data of one processing step and the specified output data of another. In such cases, each processing step may specify the range that input data can take, and the processing operation, from which information the dataflow controller may determine the range that output data can take (or the range that output data can take may be explicitly defined by the user). Processing steps are configured to execute their respective processing operations in response to a data modification event at particular input data. Thus, the generation of new output data by a processing step, which output data falls within the particular input data (or input data range) specified for another processing step, should trigger the execution of the another processing step. Therefore, links may be determined by the inclusion of the range of output data that may be generated by one processing step (wholly or partially) within the range of input data that may be accepted by another.

The cache memory controller is configured to maintain the accumulation of output data from the set of processing steps, for example, by setting a location/address (which may be fixed or may be transient) having a size sufficient to store at least one version of the output data from each processing step in the set and optionally also and identifier or label for the output of each data processing step in the set, and populating the set location/address with the latest version of the output data from each processing step when it is acquired from the dataflow controller. The cache memory controller may also be configured to receive and respond to data access requests for some or all of the accumulation. The cache memory controller may also be named an accumulator or an accumulation manager.

Once a processing step (in particular, the processing operation it specifies) has been executed, the dataflow controller obtains the output data. The dataflow controller is configured to provide the output data to a data store and/or to a data processing step linked to the executed step. In addition, if the executed processing step is included in the set of data processing steps, then the dataflow controller is configured to provide the output data directly to the cache memory controller. Directly in this sense means not via a data store or other memory (other than possibly a temporary buffer between the dataflow controller and the cache memory controller).

The updating of the maintained accumulation by the cache memory controller is performed whenever output data is provided from the dataflow controller. The updating may be simply overwriting the previous version of the data output by the processing step that generated the provided output data. The updating may also include adding the accumulation, pre- and/or post-update, to a repository of versions of the particular accumulation.

The accumulation may be utilized by analytics programs or applications. For example,

each time the maintained accumulation is updated, the cache memory controller is configured to trigger an analytics processing routine to operate on the updated accumulation.

Advantageously, the apparatus provides a mechanism to provide the analytics processing routine with the most recent version of the data on which it operates, and in a very short time after generation of those data at system runtime. An analytics processing routine may be considered to be a set of processing instructions that, when executed, perform a logical operation on data from the accumulation in order to generate a result. The analytics processing routine may generate and output its result to a user.

The data store on which the dataflow operates may be external to the apparatus, or may be a component of the same apparatus. In particular, the apparatus may further comprise a data store configured to store a database; and the dataflow controller is configured to instruct the writing to the database of the output data generated by the execution of the processing operation of the or each of at least one data processing step per dataflow specification.

In such embodiments, the accumulation of data maintained by the cache memory controller provides a more up to date view of the data in the accumulation than could be obtained by monitoring the data store itself. The database may be a graph database encoded in any form, but as an example the graph database may be encoded as a plurality of triples. Alternatively, the database may be a relational database. Alternatively, the graph database may be encoded as a plurality of data items each including a triple and including additional data values.

In addition to providing output data to the database, it may be that at least one data processing step per dataflow specification specifies an input range, the input range defining a subset of data in the database; the dataflow controller being configured to respond to a notification of a data modification event involving data in the database falling within the input range of one of the data processing steps by providing the involved data as input data and triggering execution of the processing operation of the one of the data processing steps.

A dataflow is a series of processing operations triggered by a single data modification event in a data store. Where the value of one database entity is dependent upon another, and then the value of a further database entity is dependent upon the one database entry, and so on, and so forth, it can be appreciated that a flow of processing operations to generate the new values can be triggered by a single data modification event. The data modification event types that will trigger a particular data processing step may be predetermined, and may be some or all from a predetermined set of data modification event types.

The definition of a predetermined set of data modification event types may also be reflected in the functionality of the data processing steps, insofar as the data modification event types in the predetermined set that will trigger data processing steps may also determine the data modifications that can be carried out by data processing steps.

In a graph database, data modification event types may be grouped into two subsets as follows:

Local transformation: deletion, creation, modification of attributes, of data items (resources represented by a data graph)

Connection transformation: deletion, creation, modification of attributes, of data linkages (interconnections between resources represented by the data graph).

The definition of a limited number of permissible data transformations can significantly reduce the necessary number of data processors and increase the reuse of atomic data processing units. It also simplifies the consumption of such functionalities by machines through a simplified interface.

A data modification event detector may be included in the apparatus and configured to monitor the database for data modification events that will trigger a data processing step, and to notify the dataflow controller when such data modification events are detected.

As a example of a data store upon which the dataflow controller is configured to operate: the database is a graph database representing resources interconnected by labeled links, each labeled link connecting a pair of resources and the label indicating the relationship between the pair. In terms of encoding, the data graph may be encoded as a plurality of triples, each triple comprising a value for each of: a subject, being an identifier of a subject resource; an object, being either an identifier of an object resource or a literal value; and a predicate, being a named relationship between the subject and the object.

Embodiments may also specifically encode a data graph as RDF triples, that is, triples which comply with the RDF standard. Furthermore, the data input at each processing step may be in the form of one or more triples, likewise the output data. In that way, the output data are in a form ready to be added to the database.

In embodiments in which triples represent the fundamental unit of data that is read from the database, written to the database, and exchanged between data processing steps, it may be that the input range specified by a data processing step is specified by a value range for the predicate and/or by a value range for the subject, a triple being deemed to fall within the input range by having a predicate value falling within the specified predicate value range and/or a subject value falling within the subject value range.

For example, a processing step may be configured to convert Fahrenheit values to Celsius, and therefore the input range of said processing step may be specified by the “has_fahrenheit” predicate value. That value corresponds to a range of predicate values (albeit the range is a fixed value), but also to a range of input data, because the values of the subject and object are not specified, so any data modification event at a triple with the “has_fahrenheit” predicate would trigger the processing step. Additionally, it may be that only has_fahrenheit value of a particular entity or class of entities is of interest, and this could be specified by value range for the subject. A data modification event that triggers a data processing step may be detected by monitoring the database itself, or may be new data being output by another data processing step (the two data processing steps in question being linked by the dataflow controller).

As a particular example of a data modification event that may trigger a dataflow, i.e. a data modification event involving data within the database falling within the input range of one of the data processing steps, the data modification event is a new object value in a triple having a predicate value within the specified value range for the subject and/or a subject value falling within the specified value range for the subject, the involved data being the triple. The new object value may be as a result of an entirely new triple, or may be a modification of an existing value.

The dataflow controller may be configured to use a particular schema to specify dataflows (or to store dataflow specifications). For example, the dataflow specification may include, for each data processing step, an input range and an output range, the link between each consecutive pair of data processing steps being defined by the inclusion of some or all of the output range of the preceding member of the pair in the input range of the proceeding member of the pair, each data processing step being configured, when triggered by being provided data falling within the input range of the data processing step as an input, to generate as an output data falling within output range of the data processing step by performing the processing operation specified by the data processing step on the input.

Advantageously, storing data processing steps in this manner enables links between steps to be determined based on the specified input and output ranges. For example, data processing steps can be specified without any explicit links to other data processing steps, but the specified input and output ranges contain enough information to enable the links to be surfaced or determined by the dataflow controller itself, and hence for dataflows to be constructed from individually specified steps.

A function of the apparatus is to combine the latest outputs from each of a plurality of data processing steps into a single accumulation (report/table/data item) on the cache memory. Those latest outputs can then be accessed by analytics programs. The individual outputs, that is, the identity of the data processing steps from which the output data is obtained for inclusion in the accumulation, is selectable by a user. It should be understood that a user of the apparatus may be a human user or may be an application, the application either carrying out an automated process or being under the control of a human user. Optionally, the cache memory controller includes an interface enabling a user to select data processing steps to include in the set of data processing steps.

The interface may be a graphical user interface in which a visual representation of the dataflow specifications is presented to a user. Alternatively, the interface may be a published schema enabling an accumulation template to be created or modified (an accumulation template being a space holder or schema for the output data from the selected processing steps that will be populated upon being provided output data from the dataflow controller).

The cache memory controller may maintain a plurality of accumulations, for example, in embodiments in which many analytics programs require access to the latest outputs from different combinations of data processing steps.

Rather than explicitly selecting data processing steps, it may be that the interface enables a user to specify ranges of data that are to be included in an accumulation, and the cache memory controller (in collaboration with the dataflow controller) is configured to determine which data processing steps generate output data falling within those ranges. The determined data processing steps forming the membership of the predetermined set.

In a particular example of how members of the set of data processing steps may be selected in embodiments in which the dataflow controller operates on a graph database: the interface enables the user to select data processing steps by specifying a resource represented by the data graph, the cache memory controller being configured to notify the dataflow controller of the specified resource, and the dataflow controller being configured to respond by notifying the cache controller of any data processing steps for which the specified input range includes triples in which the subject value is an identification of the specified resource. In other words, the user would like to set up an accumulation of data on the cache memory (hence easily and quickly accessible) that includes the latest version of any triples (either that are to be included in the database or even that exist only as a link between two processing steps) relating to a particular subject resource.

Furthermore, it may be that the interface enables the user to specify one or more predicate value ranges in addition to specifying the resource, the cache memory controller being configured to notify the dataflow controller of the specified resource and the one or more predicate value ranges, and the dataflow controller being configured to respond by notifying the cache controller of any processing steps for which the specified input range includes triples in which both the subject value is an identification of the specified resource, and the predicate value is included within any of the one or more specified predicate value ranges.

In such examples, the user is able to tailor the accumulation to only include particular properties of the subject resource of interest. This reduces space required for the accumulation on the cache memory and thus lessens the overall operational cost of the apparatus.

Optionally, the cache memory controller is configured to construct a schema in which to store the accumulation of output data in the cache memory.

Such embodiments enable the outputs from the set of data processing steps to be stored in a consistent manner. The schema may be published to users in order to facilitate queries. Alternatively, the entire accumulation (structured according to the schema) may be output to an analytics processing routine by the cache memory controller following completion of an update. The cache memory controller may store processing rules defining how schemas are constructed. For example, it may be a simple table with headings and one data row, the headings being identifiers of the data processing steps included in the set, and the corresponding entry in the one data row being reserved for the latest version of the output data generated by the identified data processing step.

Updating the accumulation of data is event-triggered, the event being the dataflow controller providing the cache memory controller with new output data from a processing step in the set of processing steps. Once updated, the latest version of the accumulation is made available to analytics programs. It may be that an analytics program issues a request for the accumulation as and when it is required, the advantage being that the analytics program is accessing valid (timely) data. Alternatively or additionally, it may be that the cache memory controller is configured to output the accumulation of data (in the schema) to an analytics program following each update.

The output may be as soon as possible after the update, so that the analytics program is provided the latest version of the accumulation as soon as possible after it becomes available. It may be that the analytics program is configured to perform an analytic processing routine whenever an updated version of the accumulation is received. Alternatively, it may simply be stored ready for the next execution of the analytic processing routine.

Since space on cache memory is valuable and should not be occupied by data that are unlikely to be accessed, it may be that the cache memory controller is configured to maintain only the most recent version of the output data generated by each member of the set.

In such embodiments, the update performed by the cache memory controller whenever new output data is provided by the dataflow controller may include outputting the non-updated version of the accumulation to a repository, the repository being a storage location on a permanent storage unit such as a hard disk.

Embodiments of another aspect include a method, comprising: storing one or more dataflow specifications and to control execution of the dataflow specified by the or each dataflow specification, the or each dataflow specification specifying a series of linked data processing steps, each processing step specifying a processing operation to be performed on data provided as input data in order to generate output data, and each link defining a consecutive pair relationship between two processing steps within the series, the link instructing the dataflow controller to trigger the execution of the proceeding member of the consecutive pair by, upon generation of the output data by the preceding member, providing the generated output data of the preceding member as the input data of the proceeding member; and maintaining, on a cache memory, an accumulation of the output data generated by the most recent execution of the processing operation of each member of a set of the specified data processing steps; for each member of the set of data processing steps, upon execution of the processing operation of the data processing step, obtaining the output data generated by the execution and updating the maintained accumulation with the obtained output data.

Embodiments of another aspect include a computer program which, when executed by a computing apparatus, causes the computing apparatus to function as a computing apparatus defined above as an invention embodiment.

Embodiments of another aspect include a computer program which, when executed by a computing apparatus, causes the computing apparatus to perform a method defined above or elsewhere in this document as an invention embodiment.

Furthermore, embodiments of the present invention include a computer program or suite of computer programs, which, when executed by a plurality of interconnected computing devices, cause the plurality of interconnected computing devices to perform a method embodying the present invention.

Embodiments of the present invention also include a computer program or suite of computer programs, which, when executed by a plurality of interconnected computing devices, cause the plurality of interconnected computing devices to function as a computing apparatus defined above or elsewhere in this document as an invention embodiment.

Although the aspects (software/methods/apparatuses) are discussed separately, it should be understood that features and consequences thereof discussed in relation to one aspect are equally applicable to the other aspects. Therefore, where a method feature is discussed, it is taken for granted that the apparatus embodiments include a unit or apparatus configured to perform that feature or provide appropriate functionality, and that programs are configured to cause a computing apparatus on which they are being executed to perform said method feature.

### BRIEF DESCRIPTION OF THE DRAWINGS

Preferred features of the present invention will now be described, purely by way of example, with reference to the accompanying drawings, in which:

FIG. 1 is a schematic illustration of an embodiment;

FIG. 2 is a schematic illustration of an apparatus of an embodiment, annotated with method steps;

FIG. 3 provides a specific example of a process of an embodiment;

FIG. 4 illustrates the functionality of the dataflow controller of an embodiment; and

FIG. 5 illustrates an exemplary hardware configuration of an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

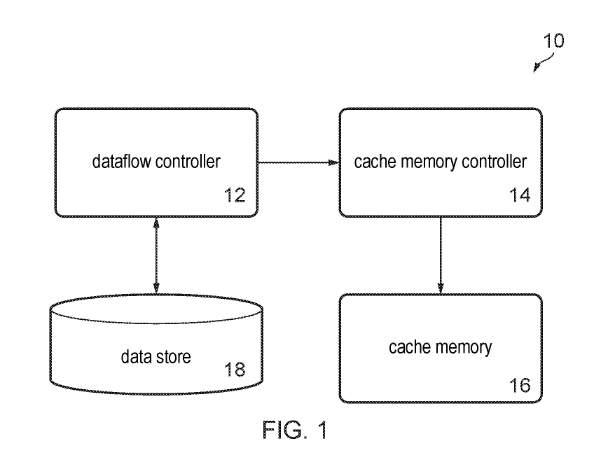

FIG. 1 is a schematic illustration of an embodiment. The system or apparatus 10 of FIG. 1 comprises a dataflow controller 12, a cache memory controller 14, and a cache memory. A data storage apparatus 18 is also illustrated, in order to emphasize the mode of operation of the dataflow controller 12. However, the database on which the dataflow controller 12 operates may or may not be stored by the apparatus 10, and may in fact be stored by one or more data storage units accessible to the dataflow controller 12 over a network, such as a Local Area Network or the internet.

The dataflow controller 12 is an entity responsible for monitoring a database (here database is used for convenience, whereas in implementation it could be any single repository 142 or multiple repositories of stored data), and for executing (or instructing the execution of) specified data processing steps to generate data for modifying the database in response to specified events. Such specified events may be monitored data modification events within the database, or could be trigger events external to the database. The execution of one data processing event whose specification is stored on the dataflow controller 12 may trigger the execution of another, and thus the two data processing steps are stored as linked, any series of linked data processing steps being a dataflow.

The dataflow controller 12 is configured to store one or more dataflow specifications and to control execution of the dataflow specified by the or each dataflow specification, the or each dataflow specification specifying a series of linked data processing steps, each processing step specifying a processing operation to be performed on data provided as input data in order to generate output data, and each link defining a consecutive pair relationship between two processing steps within the series, the link instructing the dataflow controller 12 to trigger the execution of the proceeding member of the consecutive pair by, upon generation of the output data by the preceding member, providing the generated output data of the preceding member as the input data of the proceeding member.

The dataflow controller 12 is configured to store specifications of data processing steps and to control the propagation of output data generated by the execution of individual steps. Possible output data destinations include proceeding data processing steps (i.e. an internal transfer within the dataflow controller 12), a database (i.e. the output data is included in a write access request transferred to the database), and/or the cache memory controller 14. The arrow between the dataflow controller 12 and the cache memory controller 14 in FIG. 1 represents the transfer of output data generated by a data processing step from the dataflow controller 12 to the cache memory controller 14.

The dataflow controller 12 may store specifications of a plurality of dataflows. Some of the stored dataflows may have data processing steps in common.

The dataflow controller 12 is a functional component and hence may be realized as a set of processing instructions carried out by a processor with the use of memory, and utilizing data storage or memory for storing the dataflow specification, and network I/O hardware for the exchange of data with the data storage apparatus 18. The cache memory controller 14 may be considered to be a particular functional component operating within the dataflow controller 12, or may be realized as a separate component altogether possibly on a separate device, hence the dataflow controller 12 may utilize network I/O hardware for transferring output data from data processing steps to the cache memory controller 14.

The cache memory controller 14 being is configured to maintain, on the cache memory, an accumulation of the output data generated by the most recent execution of the processing operation of each member of a set of the data processing steps specified by the dataflow controller 12. The cache memory controller 14 is configured to acquire output data from a pre-selected or predetermined set of data processing steps and store the latest output data from each of those steps as an accumulation of data in a location permitting fast read accesses. The acquisition of output data by the cache memory controller 14 and use of those output data to update the accumulation is carried out in parallel with the execution of proceeding data processing steps within the respective dataflow(s) and adding of output data to the data storage apparatus 18. Therefore, the cache memory controller 14 enables the latest version of a particular data to be accessed very quickly after it has been generated, and from an apparatus (cache memory) that facilitates fast read accesses. Furthermore, the cache memory controller 14 may be configured to trigger one or more analytics processing routines that utilize the accumulation to execute after each update.

An accumulation of data is simply the latest version of the output data from more than one data processing step, stored according to a schema and accessible as a single data entity by an analytics program.

The cache memory controller 14 is a functional component and hence may be realized as a set of processing instructions carried out by a processor with the use of memory, and utilizing data storage or memory for buffering incoming and outgoing data, and network I/O hardware for the exchange of data with the dataflow controller 12, when required. The cache memory controller 14 may be realized as a particular functional component of the dataflow controller 12. The cache memory controller 14 is in data communication with the cache memory and is authorized to allocate space within the cache memory for the particular function of storing the accumulation of data. The cache memory controller 14 is also authorized to make data write instructions/accesses to the cache memory in order to update the accumulation with the latest version of output data from a data processing step within the set of data processing steps.

The cache memory is a hardware component, and may be a non-volatile memory, or in particular a flash memory or RAM. The cache memory is accessible by the cache memory controller 14 for data write accesses, and is configured to overwrite a previous version of output data from a data processing step with a latest version, under instruction from the cache memory controller 14. For each accumulation, the cache memory controller 14 may construct a schema according to which the accumulation data is maintained by the cache memory. The schema may identify each data processing step whose output data is included in the accumulation, so that a subsequent data write access made by the cache memory controller 14 to the cache memory can include the identity of the data processing step and the output data, so that the cache memory can write the data to the appropriate location within the schema of the accumulation.

The cache memory is accessible by one or more analytics programs or analytics processing routines for data read accesses. An analytics program may access some or all of an accumulation maintained on the cache memory. The cache memory controller 14 may trigger the execution of the analytics entities each time an update is carried out.

The data storage apparatus 18 is configured to store data, and to provide an interface by which to allow read and write accesses to be made to the data by the dataflow controller 12 (or by other components cooperating with the dataflow controller 12). The dataflow controller 12 is configured to carry out data processing steps in order to modify data within the data storage apparatus 18, and to write the modified data back to the data storage apparatus 18. In a particular example, the data storage apparatus 18 is configured to store a data graph representing interconnected resources, the data graph being encoded as a plurality of triples, each triple comprising a value for each of: a subject, being an identifier of a subject resource; an object, being either an identifier of an object resource or a literal value; and a predicate, being a named relationship between the subject and the object. The triples may be RDF triples (that is, consistent with the Resource Description Format paradigm) and hence the data storage apparatus 18 may be an RDF data store. The data storage apparatus 18 may be a single data storage unit or may be an apparatus comprising a plurality of interconnected individual data storage units each storing (possibly overlapping or even duplicated) portions of the stored graph, or more specifically the triples encoding said portions of the stored graph. Regardless of the number of data storage units composing the data storage apparatus 18, the data graph is accessible via a single interface or portal to the dataflow controller 12 and optionally to other users. Users in this context and in the context of this document in general may be a human user interacting with the data storage apparatus 18 or other components via a computer (which computer may provide the hardware realizing some or all of the data storage apparatus 18 or may be connectable thereto over a network), or may be an application hosted on the same computer as some or all of the apparatus 10 or connectable to the apparatus 10 over a network (such as the internet), said application being under the control of a machine and/or a human user.

The data storage apparatus 18 may be referred to as an RDF store. The dataflow controller 12 may be referred to as a dynamic dataflow controller or dynamic dataflow engine.

The triples provide for encoding of graph data by characterizing the graph data as a plurality of subject-predicate-object expressions. In that context, the subject and object are graph nodes of the graph data, and as such are entities, objects, instances, or concepts, and the predicate is a representation of a relationship between the subject and the object. The predicate asserts something about the subject by providing a specified type of link to the object. For example, the subject may denote a Web resource (for example, via a URI), the predicate denote a particular trait, characteristic, or aspect of the resource, and the object denote an instance of that trait, characteristic, or aspect. In other words, a collection of triple statements intrinsically represents directional graph data. The RDF standard provides formalized structure for such triples.

The Resource Description Framework is a general method for conceptual description or modeling of information that is a standard for semantic networks. Standardizing the modeling of information in a semantic network allows for interoperability between applications operating on a common semantic network. RDF maintains a vocabulary with unambiguous formal semantics, by providing the RDF Schema (RDFS) as a language for describing vocabularies in RDF.

Optionally, each of one or more of the elements of the triple (an element being the predicate, the object, or the subject) is a Uniform Resource Identifier (URI). RDF and other triple formats are premised on the notion of identifying things (i.e. objects, resources or instances) using Web identifiers such as URIs and describing those identified ‘things’ in terms of simple properties and property values. In terms of the triple, the subject may be a URI identifying a web resource describing an entity, the predicate may be a URI identifying a type of property (for example, color), and the object may be a URI specifying the particular instance of that type of property that is attributed to the entity in question, in its web resource incarnation. The use of URIs enables triples to represent simple statements, concerning resources, as a graph of nodes and arcs representing the resources, as well as their respective properties and values. An RDF graph can be queried using the SPARQL Protocol and RDF Query Language (SPARQL). It was standardized by the RDF Data Access Working Group (DAWG) of the World Wide Web Consortium, and is considered a key semantic web technology.

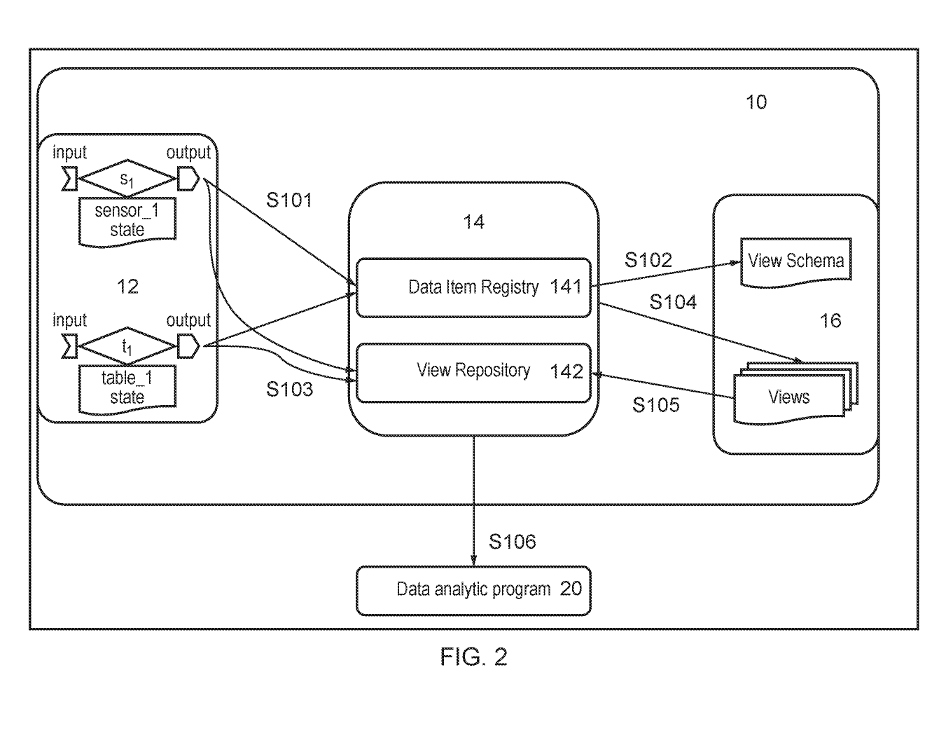

FIG. 2 is a schematic illustration of an apparatus 10 of an embodiment, annotated with method steps.

Components in the embodiments of FIG. 2 have the functionality of the correspondingly numbered components from the example of FIG. 1, in addition to the specific additional functionalities presented below.

The cache memory controller 14 is illustrated with two distinct component parts, a data item registry 141 and a view repository 142. The data item registry 141 is a record of the data processing steps composing the set of data processing steps from which the latest versions of the output data are stored in an accumulation of data. In other words, the data item registry 141 determines from which data processing steps the output data is acquired from the dataflow controller 12 in order to update an accumulation maintained by the cache memory controller 14. Once the set of data processing steps whose output data compose the accumulation of data have been selected and stored in the data item registry 141, the cache memory controller 14 is configured to generate and output a schema according to which the accumulation is stored and output.

In the embodiment of FIG. 2, accumulations of data are given the alternative name, views. A view, or an accumulation, is a collection of the latest versions of the output data from a set of data processing steps. The dataflow controller 12 of FIG. 2 includes a view repository 142, which is a store of historical versions of a particular view or accumulation. For example, it may be that prior to each update the view is output to the view repository 142, so that even though the most recently output data is accessible via the view in the cache memory, previous versions are stored and made accessible via the view repository 142. How many views are stored by the view repository 142, and whether they are stored in cache memory or in a data storage unit, will depend upon the system resources available. The plural views on the cache memory is an indication that the cache memory controller 14 may maintain a plurality of views each composed of the latest versions of data output by a different combination of data processing steps.

It is noted that where output data stored on the cache memory is referred to as the latest version of that output data, there will be a very short latency period between execution of the processing routine of a data processing step causing the generation of output data, and that data being written to the cache memory. During that latency period, the version of output data stored in any accumulation for which that data processing step is in the set of data processing steps, will be out-of-date or invalid. However, since this latency period is very short, and unavoidable, the version of the data stored in the accumulation on the cache memory can be considered to be the latest version until it is superseded by an update.

The data analytic program 20 is illustrated as external to the apparatus 10, although it may be a program running on the same device as one or more of the components of the apparatus 10. The arrow from the cache memory controller 14 to the data analytic program 20 indicates the triggering of the data analytic program 20 by the cache memory controller 14 following an update of a view/accumulation.

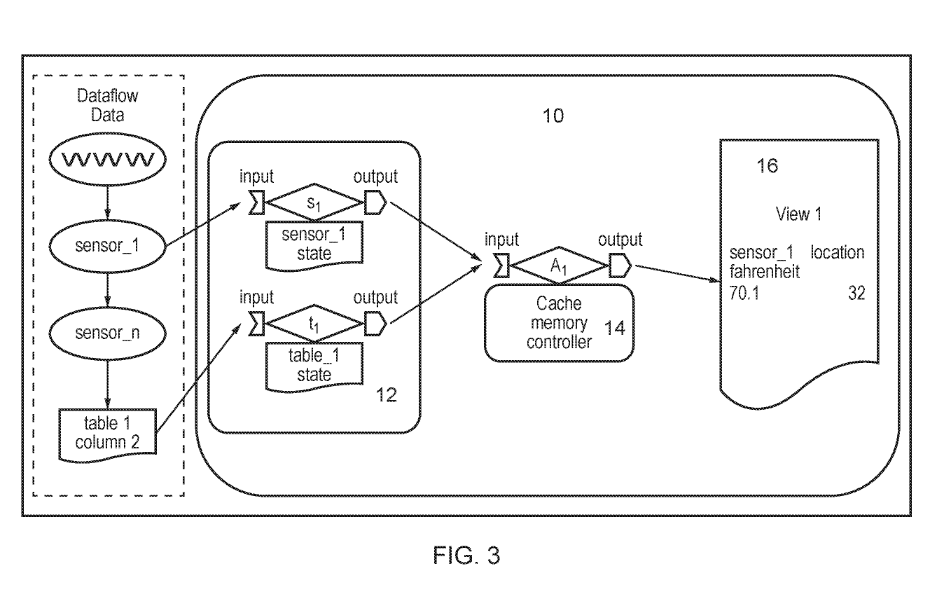

The component architecture of FIG. 2 is annotated with some method steps S101 to S106. These method steps are exemplary of the procedure followed by embodiments. FIG. 3 illustrates in more detail the processes followed in the method steps S101 to S106.

At step S101 a user performs a registration process in which a number of data processing steps whose output is to be included in an accumulation are selected. In a particular embodiment, the registration process may contain two steps:

Select a data item (e.g. a graph resource) of interest. This selection may be simply a specification of a graph resource, or may also include one or more properties of that graph resource that are of interest. This selection may be made via a statement (either directly input by the user or composed by the cache memory controller 14 based on user inputs) such as the following:

### Statement 1:

<http://fujitsu.com/2014#Sensor/sensor_1> <http://fujitsu.com/2014#has_fahrenheit> rdf:type rdf:Property

In statement 1 the first line identifies a graph resource of interest and the second line specifies the properties of interest. The selection is stored in the data item registry 141. In the example of FIG. 3, it can be seen that, among the data items in the dataflow, sensor_1 and table 1 column 2 are of interest to the user, and hence these are selected (either via an RDF statement or some other interface).

Map the data item of interest to a data processing step. With the selection made in the previous step, the cache memory controller 14 is configured to map the selection to the output of a data processing step specified by the dataflow controller 12. The cache memory controller 14 is configured to find a data processing step that accepts a property of sensor_1 as an input, and in particular one that has the predicate “has_fahrenheit”. The dataflow controller 12 may store inputs in a fixed statement format, such as the following:

Statement 6:

:input1 rdf:type dataflow:Input

:input1 dataflow:usesPredicate <http://fujitsu.com/2014#has_fahrenheit>

So that the cache memory controller 14 is aware that any data processing step whose input is labelled “input1” should be included in the set of data processing steps of the accumulation being constructed. An RDF statement such as the following may be used to specify which data processing step output data should be provided to the cache memory controller 14:

### Statement 2:

:output1 rdf:type dataflow:Output.

:output1 dataflow:usesPredicate <http://fujitsu.com/2014#has_celsius>

In the example of FIG. 3, the dataflow controller 12 stores one data processing step for which a property of sensor_1 is the input, and one data processing step for which table 1 column 2 is the input. These data processing steps are thus included in the set of data processing steps for the accumulation, and the outputs of these data processing steps are mapped to the cache memory controller 14 (that is, a notification is set up to occur upon execution of the data processing steps).

At step S102 a schema is produced by the cache memory controller 14, the schema being a structure by which to store and label the output data from the data processing steps included in the set. In a simple example, table headers for a CSV file are specified, wherein the table headers are an identifier attributed to each data processing step. In the example of FIG. 3, the schema is a table with headings “sensor_1 fahrenheit” and “location” (location being a label attributed to table 1 column 2).

At step S103, a data processing step is triggered either by being provided, as an input, the output of another data processing step, or by a notification of a state change in the database stored by the data storage apparatus 18. Such a notification may come in the form of a report from a data state modification detector 11. When a data processing step included in the membership of the set of data processing steps corresponding to (having output data included in) an accumulation generates new output data, the dataflow controller 12 transfers the new output data to the cache memory controller 14. This transfer of output data may be achieved by the dataflow controller 12 pushing the output data from the data processing step to the cache memory controller 14, or may be achieved by the cache memory controller 14 observing an output port of the data processing step, and pulling the output data after each execution. At step S104, the cache memory controller 14 uses the new output data to update the accumulation in the cache memory 16. In the example of FIG. 3, whenever the object value of the has-fahrenheit predicate linking to sensor_1 is modified, or the table entry at table 1 column 2 is modified, the accumulator is notified, and “View 1” is modified. The function performed by the cache memory controller 14 is in parallel with the execution of the dataflow and the writing of data generated in the dataflow back to the database. Delivery time to the analytics program is saved and data freshness optimized.

At step S105, a version of the accumulation is saved to the view repository 142. It may be that the updated version is saved to the view repository 142 post-update. In this manner, the saving of the accumulation to the view repository 142 does not delay the update of the accumulation. At step S106, following the update of the accumulation, the cache memory controller 14 triggers a data analytic program 20, which program performs an operation on the updated accumulation in the cache memory 16. The data analytic program 20 may be an off-the-shelf analytics process. Alternatively, analytic processes could be built-in to the apparatus 10 that incrementally yield/generate more data for further analysis. For example, a simple built-in process could be getting a statistic on which sensor in a room has the highest temperature, which analytics process could operate on an accumulation of temperature readings from all sensors located in the room and represented in the data graph, whenever the temperature property of one of the sensors is updated.

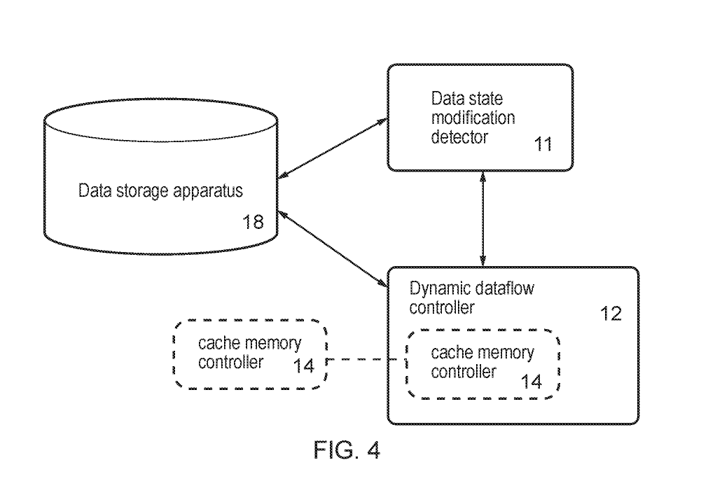

An exemplary dataflow controller 12 will now be discussed in more detail, with reference to FIG. 4. In this particular example, the dataflow controller 12 is referred to as a dynamic dataflow controller. The dynamic dataflow controller has the functionality of the dataflow controller 12 of FIG. 1, in addition to the further functionality set out below. The data storage apparatus 18 in this example corresponds to the data storage apparatus 18 of FIG. 1. The data processing steps referred to elsewhere in this document are referred to as processor instances in this example. The cache memory controller 14 of FIGS. 1 to 3 could be included as a component of the dataflow controller of FIG. 4, or alternatively could function in cooperation with the dataflow controller of FIG. 4. Both alternatives are illustrated in dashed lines in FIG. 4.

FIG. 4 illustrates a dynamic dataflow controller 12 configured to operate in cooperation with a data state modification detector 11.

The cache memory controller 14 of FIG. 4 is the same as the cache memory controller 14 of FIGS. 1 to 3.

The data storage apparatus 18 is configured to store data, and to provide an interface by which to allow read and write accesses to be made to the data. Specifically, the data storage apparatus 18 is configured to store a data graph representing interconnected resources, the data graph being encoded as a plurality of triples, each triple comprising a value for each of: a subject, being an identifier of a subject resource; an object, being either an identifier of an object resource or a literal value; and a predicate, being a named relationship between the subject and the object. The triples may be RDF triples (that is, consistent with the Resource Description Format paradigm) and hence

The arrow between the data storage apparatus 18 and the dynamic dataflow controller 12 indicates the exchange of data between the two. The dynamic dataflow controller 12 stores and triggers the execution of processor instances which take triples from the data storage apparatus 18 as inputs, and generate output triples that are in turn written back to the data storage apparatus 18.

The dynamic dataflow controller 12 is configured to store a plurality of processor instances, each processor instance specifying an input range, a process, and an output range, each processor instance being configured, when triggered by the provision of an input comprising a triple falling within the input range, to generate an output comprising a triple falling within the output range, by performing the specified process on the input. The processor instances may specify the input range, process, and output range explicitly, or by reference to named entities defined elsewhere. For example, an input range may be defined in an RDF statement stored by the dynamic dataflow controller 12 (or by some other component such as a data state transformation detector 11) and given a label. The processor instance may simply state the label, rather than explicitly defining the input range, and the output range may be specified in the same manner. The process (processing routine) may be stored explicitly, for example as processing code or pseudo-code, or a reference to a labelled block of code or pseudo-code stored elsewhere (such as by a generic processor repository) may be specified.

The actual execution of the process specified by a processor instance may be attributed to the processor instance itself, to the dynamic dataflow controller 12, or to the actual hardware processor processing the data, or may be attributed to some other component or combination of components.

Processor instances are triggered (caused to be executed) by the dynamic dataflow controller 12 in response to data modification events occurring involving triples falling within the specified input range. The dynamic dataflow controller 12 is configured to respond to a data modification event involving a triple falling within the input range of one of the stored processor instances by providing the triple involved in the data modification event to the one of the stored processor instances as (all or part of) the input. The actual procedure followed by the dynamic dataflow controller 12 in response to being notified that a data modification event has occurred involving a triple falling within the input range of a processor instance may be to add the processor instance or an identification thereof to a processing queue, along with the triple involved in the data modification event (and the rest of the input if required). In that way, the dynamic dataflow controller 12 triggers the processor instance by providing the input. The data modification events may occur outside of the dynamic dataflow controller 12 (for example, by a user acting on the data storage apparatus 18 or by some process internal to the data graph such as reconciliation), or may be the direct consequence of processor instances triggered by the dynamic dataflow controller 12.

Triples included in the output of a processor instance once executed are written back to the data graph (for example by adding to writing queue). In addition, the dynamic dataflow controller 12 is configured to recognize when the output of an executed processor instance will trigger the execution of another processor instance, and to provide the output in those cases directly to another processor instance, thus forming a dataflow. In other words, following the generation of the output by the triggered processor instance, to provide a triple comprised in the output as the input to any processor instance, from among the plurality of processor instances, specifying an input range covering the triple comprised in the output. The recognition may take place by a periodic or event-based (an event in that context being, for example, addition of a new processor instance) comparison of input ranges and output ranges specified for each processor instance. Where there is a partial overlap between the output range of one processor instance and the input range of another, the dynamic dataflow controller 12 is configured to store and indication that the two are linked, and on an execution-by-execution basis to determine whether or not the particular output falls within the input range. Another destination for outputs is the cache memory controller, 14, when the processor instance is included in a set of processor instances whose most recent outputs are maintained in a view/accumulation on a cache memory by the cache memory controller 14.

The data state modification detector 11 is configured to monitor or observe the data (triples) stored on the data storage apparatus 18 in order to detect when a data modification event involving a triple included in (which may be termed falling within or covered by) the input range of a processor instance stored on the dynamic dataflow controller 12. The data state modification detector 11, upon detecting any such data modification event, is configured to notify the dynamic dataflow controller 12 at least of the triple involved in the data modification event, and in some implementations also a time stamp of the detected data modification event (or a time stamp of the detection), and/or an indication of a type of the detected data modification event.

A data modification event involving a triple may include the triple being created, the object value of the triple being modified, or another value of the triple being modified. The triple being created may be as a consequence of a new subject resource being represented in the data graph, or it may be as a consequence of a new interconnection being added to a subject resource already existing in the data graph. Furthermore, a data modification event may include the removal/deletion of a triple from the data graph, either as a consequence of the subject resource of the triple being removed, or as a consequence of the particular interconnection represented by the triple being removed. Furthermore, a triple at the class instance level (i.e. representing a property of an instance of a class) may be created, modified, or removed as a consequence of a class level creation, modification, or removal. In such cases, the data state modification detector 11 is configured to detect (and report to the dynamic dataflow controller 12) both the class level creation/modification/removal, and the creation/modification/removal events that occur at the instances of the modified class. Each of the events described in this paragraph may be considered to be types of events, since they do not refer to an actual individual event but rather to the generic form that those individual events may take.

As an example, the ontology definition of a class may be modified to include a new (initially null or zero) property with a particular label (predicate value). Once the ontology definition of a class is modified by the addition of a new triple with the new label as the predicate value, the same is added to each instance of the class.

The data state modification detector 11 is illustrated as a separate entity from the data storage apparatus 18 and the dynamic dataflow controller 12. It is the nature of the function carried out by the data state modification detector 11 that it may actually be implemented as code running on the data storage apparatus 18. Alternatively or additionally, the data state modification detector 11 may include code running on a controller or other computer or apparatus that does not itself operate as the data storage apparatus 18, but is connectable thereto and permitted to make read accesses. The precise manner in which the data state modification detector 11 is realized is dependent upon the implementation details not only of the detector 11 itself, but also of the data storage apparatus 18. For example, the data storage apparatus 18 may itself maintain a system log of data modification events, so that the functionality of the data state modification detector 11 is to query the system log for events at triples falling within specified input ranges. Alternatively, it may be that the data state modification detector 11 itself is configured to compile and compare snapshots of the state of the data graph (either as a whole or on a portion-by-portion basis) in order to detect data modification events. The interchange of queries, triples, and/or functional code between the data storage apparatus 18 and the data state modification detector 11 is represented by the arrow connecting the two components.

The input ranges within which the data state modification detector 11 is monitoring for data modification events may be defined by a form of RDF statement, which statements may be input by a user either directly to the data state modification detector 11, or via the dynamic dataflow controller 12. The statements may be stored by or at both the data state transformation detector (to define which sections of the data graph to monitor) and at the dynamic dataflow controller 12 (to define which processor instances to trigger), or at a location accessible to either or both. The arrow between the data state modification detector 11 and the dynamic dataflow controller 12 represents an instruction from the dynamic dataflow controller 12 to the data state modification to detect to monitor particular input ranges, and the reporting/informing of data modification events involving triples within those particular input ranges by the data state modification detector 11 to the dynamic dataflow controller 12.

The data state modification detector 11 is configured to detect data modification events and to report them to the dynamic dataflow controller 12. The form of the report is dependent upon implementation requirements, and may be only the modified triple or triples from the data storage apparatus 18. Alternatively, the report may include the modified triple or triples and an indication of the type of the data modification event that modified the triple or triples. A further optional detail that may be included in the report is a timestamp of either the data modification event itself or the detection thereof by the data state modification detector 11 (if the timestamp of the event itself is not available).

Some filtering of the reports (which may be referred to as modification event data items) may be performed, either by the data state modification detector 11 before they are transferred to the dynamic dataflow controller 12, or by the dynamic dataflow controller 12 while the reports are held in a queue, awaiting processing.

The filtering may include removing reports of data modification events of a creation type which are followed soon after (i.e. within a threshold maximum time) by a data modification event of a deletion type of the data identified in the creation type event.

The filtering may also include identifying when, in embodiments in which the data graph includes an ontology definition defining a hierarchy of data items, the queue includes a report of a data modification event including a first resource (or other concept) as the subject of the reported triple that is hierarchically superior (i.e. a parent concept of) one or more other resources included in other reports in the queue. In such cases, the reports including the hierarchically inferior resources (that is to say, the subject resource identified in those triples is a child concept of the first resource) are removed from the queue. Such removal may be on condition of the reports relating to data modification events of the same type.

The filtering may also include identifying when the triples identified in two different reports are semantically equivalent, and removing one of the two reports from the queue. The selection of which report to remove may be based on a timestamp included in the report, for example, removing the least recent report.

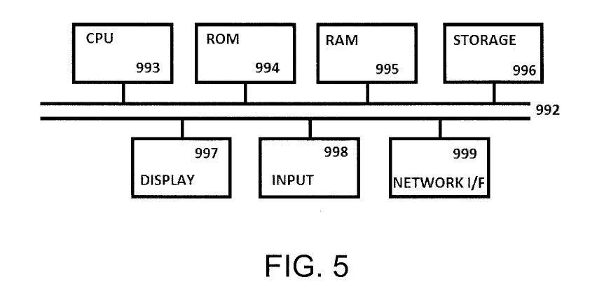

FIG. 5 is a block diagram of a computing device, such as a data storage server, or computer, which embodies the present invention, and which may be used to implement a method of an embodiment. An apparatus of an embodiment may be realized by a hardware configuration such as that of FIG. 5. The computing device comprises a computer processing unit (CPU) 993, memory, such as Random Access Memory (RAM) 995, and storage, such as a hard disk, 996. Optionally, the computing device also includes a network interface 999 for communication with other such computing devices of embodiments. For example, an embodiment may be composed of a network of such computing devices. Optionally, the computing device also includes Read Only Memory 994, one or more input mechanisms such as keyboard and mouse 998, and a display unit such as one or more monitors 997. The components are connectable to one another via a bus 992.

The CPU 993 is configured to control the computing device and execute processing operations. The RAM 995 stores data being read and written by the CPU 993. The storage unit 996 may be, for example, a non-volatile storage unit, and is configured to store data.

The display unit 997 displays a representation of data stored by the computing device and displays a cursor and dialog boxes and screens enabling interaction between a user and the programs and data stored on the computing device. The input mechanisms 998 enable a user to input data and instructions to the computing device.
The network interface (network I/F) 999 is connected to a network, such as the Internet, and is connectable to other such computing devices via the network. The network I/F 999 controls data input/output from/to other apparatus via the network.

Other peripheral devices such as microphone, speakers, printer, power supply unit, fan, case, scanner, trackerball etc may be included in the computing device.

The apparatus of an embodiment may be embodied as functionality realized by a computing device such as that illustrated in FIG. 5. The functionality of the apparatus may be realized by a single computing device or by a plurality of computing devices functioning cooperatively via a network connection. Methods embodying the present invention may be carried out on, or implemented by, a computing device such as that illustrated in FIG. 5. One or more such computing devices may be used to execute a computer program of an embodiment. Computing devices embodying or used for implementing embodiments need not have every component illustrated in FIG. 5, and may be composed of a subset of those components. A method embodying the present invention may be carried out by a single computing device in communication with one or more data storage servers via a network.

The data state modification detector 11 may comprise processing instructions stored on a storage unit 996, a processor 993 to execute the processing instructions, and a RAM 995 to store information objects during the execution of the processing instructions.

The data storage apparatus 18 may comprise processing instructions stored on a storage unit 996, a processor 993 to execute the processing instructions, and a RAM 995 to store information objects during the execution of the processing instructions.

The dynamic dataflow controller 12 may comprise processing instructions stored on a storage unit 996, a processor 993 to execute the processing instructions, and a RAM 995 to store information objects during the execution of the processing instructions.

The cache memory controller 14 may comprise processing instructions stored on a storage unit 996, a processor 993 to execute the processing instructions, and a RAM 995 to store information objects during the execution of the processing instructions.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An apparatus, comprising:
a dataflow controller configured to store at least one dataflow specification and to control execution of dataflow specified by the dataflow specification, the dataflow specification specifying a series of linked data processing steps, each processing step specifying a processing operation to be performed on data provided as input data to generate output data, and each link defining a consecutive pair relationship between two processing steps within the series, the link instructing the dataflow controller to trigger execution of a preceding member of the consecutive pair by, upon generation of the output data by the preceding member, providing generated output data of the preceding member as the input data of the preceding member; and
a cache memory and cache memory controller, the cache memory controller being configured to maintain, on the cache memory, an accumulation of the output data generated by a most recent execution of the processing operation of each member of a set of data processing steps specified by the dataflow controller;
the dataflow controller being configured, for each member of the set of data processing steps, upon execution of the processing operation of a data processing step, to provide the generated output data directly to the cache memory controller;
the cache memory controller being configured, upon being provided the generated output data directly from the dataflow controller, to update a maintained accumulation.

2. An apparatus according to claim 1, wherein each time the maintained accumulation is updated, the cache memory controller is configured to trigger an analytics processing routine to operate on the maintained accumulation.

3. An apparatus according to claim 1, wherein
the apparatus further comprises a data store configured to store a database; and
the dataflow controller is configured to instruct writing to the database of the output data generated by the execution of the processing operation of the at least one data processing step per dataflow specification.

4. An apparatus according to claim 3, wherein
at least one data processing step per dataflow specification specifies an input range, the input range defining a subset of data in the database;
the dataflow controller being configured to respond to a notification of a data modification event involving data in the database falling within an input range of one of the data processing steps by providing involved data as input data and triggering execution of the processing operation of one of the data processing steps.

5. An apparatus according to claim 3, wherein the database is a graph database representing interconnected resources, a data graph being encoded as a plurality of triples, each triple comprising a value for each of: a subject, being an identifier of a subject resource; an object, being one of an identifier of an object resource and a literal value; and a predicate, being a named relationship between the subject and the object.

6. An apparatus according to claim 5, wherein the input range specified by a data processing step is specified by one of a value range for the predicate and by a value range for the subject, a triple being deemed to fall within the input range by having one of a predicate value falling within a specified predicate value range and a subject value falling within a subject value range.

7. An apparatus according to claim 1, wherein the dataflow specification includes, for each data processing step, an input range and an output range, the link between each consecutive pair of data processing steps being defined by the inclusion of one of some and all of the output range of the preceding member of the pair in the input range of the preceding member of the pair, each data processing step being configured, when triggered by being provided data falling within the input range of the data processing step as an input, to generate output data falling within an output range of the data processing step by performing the processing operation specified by the data processing step on the input.

8. An apparatus according to claim 1, wherein the cache memory controller includes an interface enabling a user to select data processing steps to include in the set of data processing steps.

9. An apparatus according to claim 8, wherein the interface enables the user to select data processing steps by specifying a resource represented by a data graph, the cache memory controller being configured to notify the dataflow controller of a specified resource, and the dataflow controller being configured to respond by notifying the cache controller of any data processing steps for which a specified input range includes triples in which a subject value is an identification of the specified resource.

10. An apparatus according to claim 8, wherein the interface enables the user to specify at least one predicate value range in addition to specifying a resource, the cache memory controller being configured to notify the dataflow controller of a specified resource and the at least one predicate value range, and the dataflow controller being configured to respond by notifying the cache controller of any processing steps for which a specified input range includes triples in which both the subject value is an identification of the specified resource, and predicate value is included within any of the at least one specified predicate value range.

11. An apparatus according to claim 1, wherein the cache memory controller is configured to construct a schema in which to store the accumulation of output data in the cache memory.

12. An apparatus according to claim 1, wherein the cache memory controller is configured to output the accumulation of data to an analytics program following each update.

13. An apparatus according to claim 1, wherein the cache memory controller is configured to maintain only a most recent version of the output data generated by each member of the set.

14. A method, comprising:
storing at least one dataflow specification and to control execution of the dataflow specified by the dataflow specification, the dataflow specification specifying a series of linked data processing steps, each processing step specifying a processing operation to be performed on data provided as input data to generate output data, and each link defining a consecutive pair relationship between two processing steps within the series, the link instructing the dataflow controller to trigger execution of a preceding member of the consecutive pair by, upon generation of the output data by the preceding member, providing generated output data of the preceding member as the input data of the preceding member; and
maintaining, on a cache memory, an accumulation of the output data generated by a most recent execution of the processing operation of each member of a set of the specified data processing steps;
for each member of the set of data processing steps, upon execution of the processing operation of the data processing step, obtaining the output data generated by the execution and updating a maintained accumulation with the obtained output data.

15. A non-transitory storage medium storing a computer program which, when executed by a computing device, causes the computing device to perform the method of claim 14.
